(19) United States
(12) Patent Application Publication
(10) Pub. No.: US 2013/0235125 A1
(43) Pub. Date: Sep. 12, 2013

(54) INKJET HEAD AND METHODS FOR FORMING SAME

(71) Applicant: TOSHIBA TEC KABUSHIKI KAISHA, Tokyo (JP)

(72) Inventor: Masashi SEKI, Shizuoka (JP)

(73) Assignee: Toshiba Tec Kabushiki Kaisha, Tokyo (JP)

(21) Appl. No.: 13/736,757

(22) Filed: Jan. 8, 2013

(30) Foreign Application Priority Data
Mar. 12, 2012 (JP) 2012-055149

(51) Int. Cl. B41J 2/14; B41J 2/16

(52) U.S. Cl. CPC B41J 2/14201; B41J 2/1607
USPC 347/71; 29/890.1

(57) ABSTRACT

According to one embodiment, an inkjet head has a pressure chamber configured to pressurize ink, a nozzle connected to the pressure chamber configured to eject the ink, and an electrode arranged in the pressure chamber. The electrode is configured to receive a driving voltage to deform the pressure chamber in order to apply pressure on the ink. A parylene film covers the electrode. The parylene film is configured to protect the electrode from the ink. A barrier film is deposited on the parylene film. The barrier film is configured to isolate the parylene film from oxygen.

### CROSS-REFERENCE TO RELATED APPLICATION

This application is based upon and claims the benefit of priority from Japanese Patent Application No. 2012-055149, filed Mar. 12, 2012; the entire contents of which are incorporated herein by reference.

### FIELD

Embodiments described herein relate to an inkjet head wherein an electrode is covered by a parylene film, and methods for forming same.

### BACKGROUND

An inkjet head that ejects ink from plural nozzles has plural slots for feeding the ink, and it has electrodes formed in each slot from the bottom surface to the side surface. If the electrodes are exposed to the ink, the electrodes may be dissolved so that wire breakage takes place, due to the characteristics of the ink. Consequently, for a related inkjet head, the electrodes are covered by a parylene film to protect the electrodes from the ink.

For the parylene film, the probability of generation of pinholes is lower than films made from various types of oxides and nitrides. Consequently, even when various types of water soluble or electroconductive inks are utilized, it is still impossible to guarantee electrical insulation between the ink and the electrode. For example, a parylene film composed mostly of polyparaxylene may deteriorate in insulation characteristics when such film reacts with oxygen. Thus, when the parylene film is exposed to oxygen in the atmosphere while the parylene film is deposited on an electrode, it is difficult for the parylene film to maintain its original insulation characteristics.

As a result, the electrode is not sufficiently protected, and durability of the inkjet head is reduced.

### DESCRIPTION OF THE DRAWINGS

FIG. 1 is an oblique view of the inkjet head according to an embodiment.

FIG. 2 is a plane view of the inkjet head according to the embodiment.

FIG. 3 is a cross-sectional view illustrating the inkjet head, taken across F3-F3 in FIG. 2.

FIG. 4 is a cross-sectional view of the inkjet head, taken across F4-F4 in FIG. 3.

FIG. 5 is an enlarged cross-sectional view illustrating the F5 portion of FIG. 4.

FIG. 6 is a characteristics diagram illustrating the UV absorption spectrum of the parylene film, according to an embodiment.

### DETAILED DESCRIPTION

According to an embodiment of the present disclosure, an inkjet head has a pressure chamber configured to pressurize ink, a nozzle connected to the pressure chamber configured to eject the ink, and an electrode arranged in the pressure chamber. The electrode is configured to receive a driving voltage to deform the pressure chamber in order to apply pressure on the ink. A parylene film covers the electrode. The parylene film is configured to protect the electrode from the ink. A barrier film is deposited on the parylene film. The barrier film is configured to isolate the parylene film from oxygen.

According to an embodiment of the present disclosure, an inkjet head has a pressure chamber configured to pressurize ink, and an electrode arranged in the pressure chamber. The electrode is configured to receive a driving voltage applied to it to deform the pressure chamber in order to apply pressure on the ink. A parylene film covers the electrode in the pressure chamber. A barrier film is deposited on the parylene film. The barrier film contains no oxygen and is exposed in the pressure chamber.

According to another embodiment of the present disclosure, an inkjet head is formed. A slot is formed in a body. A nozzle plate having a nozzle is bonded to the body to cover the slot and to form a pressure chamber. An electrode is formed in the slot, the electrode being configured to receive a driving voltage to deform the pressure chamber in order to eject ink from the nozzle. A parylene film is formed on the electrode, the parylene film being configured to protect the electrode from the ink. A barrier film is formed on the parylene film, the barrier film configured to isolate the parylene film from oxygen.

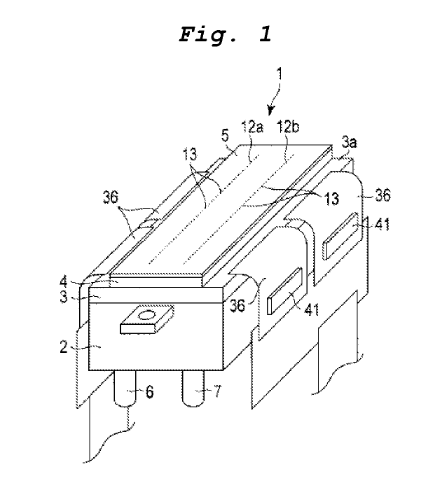

FIGS. 1 to 3 show an on-demand type inkjet head 1 carried on a carriage of a printer, according to an embodiment. The inkjet head 1 has an ink vessel 2, a substrate 3, a spacer 4 and a nozzle plate 5.

The ink vessel 2 is connected to an ink cartridge (not shown) via an ink feeding pipe 6 and the ink returning pipe 7.

The substrate 3 has a rectangular shape. The substrate 3 has a slender assembling surface 3a and is superposed on the ink vessel 2 to cover the open end of the ink vessel 2. The substrate 3 may be made of alumina (Al₂O₃), silicon nitride (Si₃N₄), silicon carbide (SiC), aluminum nitride (AlN), lead zirconate titanate (PZT: Pb(Zr, Ti)O₃), etc.

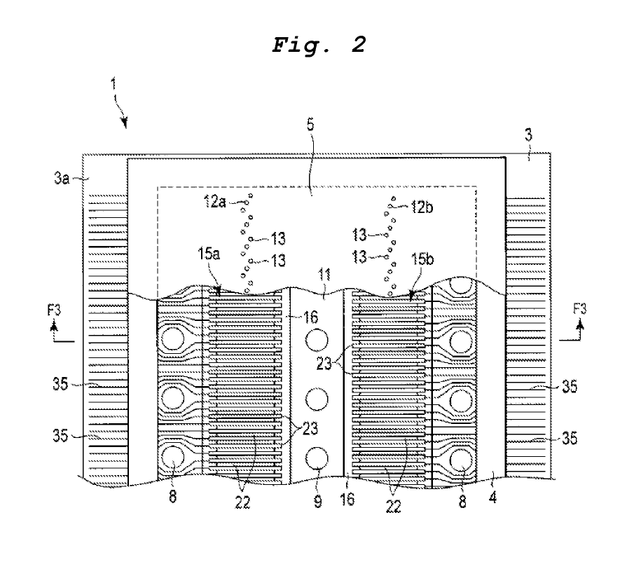

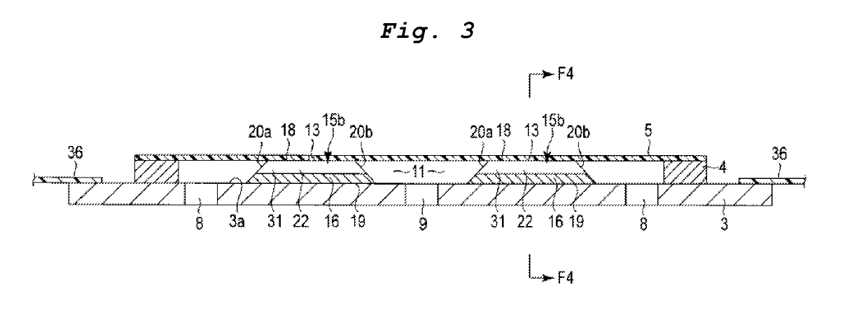

As shown in FIGS. 2 and 3, plural ink feeding ports 8 and plural ink exhausting ports 9 are arranged on the substrate 3. The ink feeding ports 8 and the ink exhausting ports 9 have openings on the assembling surface 3a of the substrate 3.

The ink feeding ports 8 are arranged so that the respective openings on a first side of the substrate 3 and on a second side of the substrate Sin the lateral direction of the substrate 3 are set as a row. The openings of the ink feeding ports on the first side of the substrate 3 have a uniform spacing between each other in the longitudinal direction of the substrate 3. Likewise, the openings of the ink feeding ports on the second side of the substrate 3 have a uniform spacing between each other in the longitudinal direction of the substrate 3

The ink exhausting ports 9 are arranged so that the openings form a column with uniform spacing between each other in the longitudinal direction of the substrate 3.

The spacer 4 has a quadrangle frame shape. The spacer 4 is bonded on the assembling surface 3a of the substrate 3, and it surrounds the ink feeding ports 8 and ink exhausting ports 9.

The nozzle plate 5 is bonded on the spacer 4 and facing the assembling surface 3a of the substrate 3. The nozzle plate 5 may be made of a 50-μm-thick polyimide film.

As shown in FIG. 3, the substrate 3, the spacer 4 and the nozzle plate 5 together form an ink flowing chamber 11. The ink flowing chamber 11 is connected to the ink vessel 2 via the ink feeding ports 8 and the ink exhausting ports 9. The ink feeding ports 8 feed the ink from the ink vessel 2 to the ink flowing chamber 11. The excessive quantity of the ink fed to the ink flowing chamber 11 is recycled to the ink vessel 2 through the ink exhausting ports 9.

As shown in FIGS. 1 and 2, a pair of nozzle rows 12a, 12b are formed on the nozzle plate 5. The nozzle rows 12a, 12b are formed extending in the longitudinal direction of the nozzle plate 5 with uniform spacing between individual nozzles 13, discussed further below. The nozzle rows 12a, 12b are arranged parallel with each other in the lateral direction of the nozzle plate 5.

The nozzle rows 12a, 12b each have plural nozzles 13. The nozzles 13 are minute holes through the nozzle plate 5 in the thickness direction. For example, a diameter of a nozzle 13 may be measured in microns. The nozzles 13 are arranged side-by-side with a uniform spacing between them. The nozzles include a first end opened to the ink flowing chamber 11. The nozzles also include a second end arranged facing a recording media for printing.

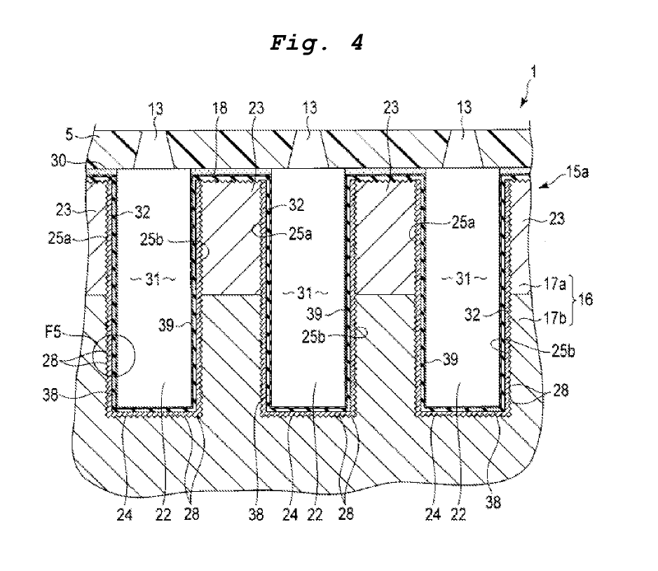

As shown in FIG. 4, the nozzles 13 are each formed with a tapered shape having a diameter increasing gradually towards the ink flowing chamber 11. For the nozzles 13 in the present embodiment, for example, when the ink ejecting rate is 3 pL, the diameter of the second end (opening towards the ink flowing chamber 11) is 40 μm, and the diameter of the first end (opening towards the recording media) is 20 μm. The dimensions of the nozzles 13 are of preset values corresponding to the ejecting rate of the ink.

As shown in FIGS. 2 and 3, a pair of actuators 15a, 15b are accommodated in the ink flowing chamber 11. One actuator 15a is bonded on the assembling surface 3a of the substrate 3 located right below one nozzle row 12a. The other actuator 15b is bonded on the assembling surface 3a of the substrate 3 located right below the other nozzle row 12b.

The actuators 15a, 15b are a common structure. Consequently, in the present embodiment, only one actuator 15a will be explained as an example. The same keys as those in the above are adopted for the other actuator 15b, and they will not be explained in detail again.

The actuator 15a has a slender main body 16 extending along the nozzle row 12a. As shown in FIG. 4, the main body 16 is composed of two piezoelectric members 17a, 17b. The piezoelectric members 17a, 17b are superposed and bonded with each other in the thickness direction. Further, the polarization directions of the piezoelectric members 17a, 17b are opposite to each other in the thickness direction.

According to some embodiments, the piezoelectric members 17a, 17b maybe made of lead zirconate titanate (PZT), lithium niobate (LiNbO₃), lithium titanate (LiTaO₃), etc. In one embodiment, PZT with a high piezoelectric constant is adopted.

The main body 16 has an outer surface 18, a back surface 19 and side surfaces 20a, 20b. The outer surface 18 faces the nozzle plate 5. The back surface 19 is located on the side opposite to the outer surface 18, and it faces the assembling surface 3a of the substrate 3.

One end of side surface 20a extends along the lateral direction of the outer surface 18 and another end extends along the lateral direction of the back surface 19. Likewise, with respect to the other side surface 20b, one end extends along the lateral direction of the outer surface 18 and another end extends along the lateral direction of the back surface 19. In addition, the side surfaces 20a, 20b are inclined so that they become farther from each other from the outer surface 18 towards the back surface 19.

As shown in FIGS. 2 and 4, plural slots 22 are formed on the main body 16. The slots 22 are formed side-by-side as a sequence with a uniform spacing between them in the longitudinal direction of the main body 16. The slots 22 are connected to and opened on the outer surface 18 and side surfaces 20a, 20b of the main body 16. Along the main body, the portion located between the slots 22 of the main body 16 works as a wall 23 that separates the adjacent slots 22.

As shown in FIG. 4, the slots 22 are each defined by a bottom surface 24 and a pair of side surfaces 25a, 25b. The side surfaces 25a, 25b are arranged facing each other with a uniform spacing in the lateral direction of the slots 22. In addition, the slots 22 go through the piezoelectric member 17a on the upper side to reach halfway along the thickness direction of the piezoelectric member 17b on the lower side. Consequently, the bottom surface 24 of the slots 22 is made of the piezoelectric member 17b on the lower side.

The depth of the slots 22 is selected to be larger than the width of the slots 22. The aspect ratio defined to be the ratio of depth to width (depth/width) of the slots 22 is greater than 1.0, i.e., the slots 22 are deeper than they are wide. The aspect ratio and the spacing of the slots 22 are selected at prescribed values corresponding to a resolution and an ink ejecting rate desired for the inkjet head 1.

According to the present embodiment, the slots 22 are formed by cutting operation using, e.g., a diamond blade on the main body 16. As shown in FIG. 4, on the bottom surfaces 24 and side surfaces 25a, 25b of the slots 22 and the inner surfaces of slots 22, plural protrusions/recessions 28 are formed. The plural protrusions/recessions 28 have a width measured in microns. In addition, in the process of cutting the main body 16, the inner surfaces of the slots 22 are partially lost because the main body 16 made of PZT is brittle. As a result, the inner surfaces of the slots 22 after cutting become rough surfaces without smoothness.

As shown in FIG. 4, the nozzle plate 5 is bonded on the outer surface 18 of the main body 16 where the slots 22 are opened via an adhesive 30. The spaces defined by the slots 22 and the nozzle plate 5 form plural pressure chambers 31. The pressure chambers 31 are connected to the ink flowing chamber 11 so that the fed ink flows into the ink flowing chamber 11. In addition, the nozzles 13 of the nozzle plate 5 are each open in the central portion of the respective individual pressure chambers 31.

Electrodes 32 are arranged on the inner side of the pressure chambers 31, respectively. The electrodes 32 cover the entire bottom surfaces 24 of slots 22 and the entire side surfaces 25a, 25b of the slots 22. The electrodes 32 of the adjacent slots 22 are cut from each other so that they are electrically independent from one another.

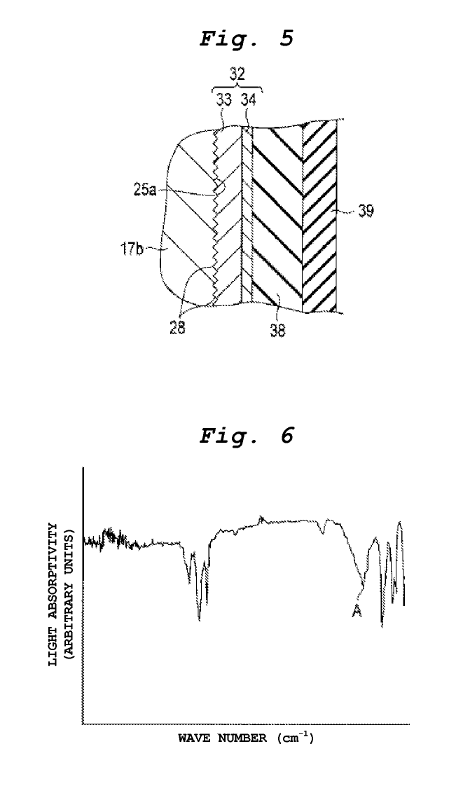

As shown in FIG. 5, the electrodes 32 have a double-layer structure including, e.g., a nickel plating layer 33 and a gold plating layer 34. Here, the nickel plating layer 33 is formed by performing electroless nickel plating on the main body 16 and the slots 22. The thickness of the nickel plating layer 33 is, for example, 0.8 μm.

The gold plating layer 34 is formed by performing electrolytic gold plating on the nickel plating layer 33. The gold plating layer 34 is laminated on the nickel plating layer 33, so that the nickel plating layer 33 is coated. The thickness of the gold plating layer 34 is, for example, 0.1 μm.

The electrodes 32 are electrically connected to the plural conductor patterns 35 formed on the assembling surface 3a of the substrate 3. The tips of the conductor patterns 35 extend outside the spacer 4, and, at the same time, they are connected to plural tape carrier patterns 36. The tape carrier patterns 36 carry driver signals that drives the inkjet head 1.

The driver signals apply driving pulses (driving voltage) to the electrodes 32 of the inkjet head 1. As a result, a potential difference takes place between the adjacent electrodes 32 with the pressure chamber 31 sandwiched between them. Also, electric fields are generated on the side surfaces 25a, 25b of the slots 22 corresponding to the electrodes 32. As a result, the side surfaces 25a, 25b are deformed in the shear mode, and the ink in the pressure chambers 31 is pressurized. A portion of the pressurized ink forms plural ink droplets that are ejected from the nozzles 13 towards the recording media.

As shown in FIGS. 4 and 5, the electrodes 32 of the slots 22 are each covered with a parylene film 38. The parylene film is formed from an organic material mainly made of polyparaxylene. The parylene film 38 is laminated on the gold plating layer 34, which is the outer layer of the electrodes 32. The parylene film 38 protects the electrodes 32 from the ink fed into the pressure chambers 31.

The bottom surface 24 and side surfaces 25a, 25b of the slots 22 as the base of the electrodes 32 are rough surfaces with plural minute bumps/dips 28. Consequently, the electrodes 32 are affected by the surface roughness of the bottom surfaces 24 and side surfaces 25a, 25b of the slots 22. In other words, when the bottom surfaces 24 and side surfaces 25a, 25b of the slots 22 are rougher, the bumps/dips 28 are not absorbed when they are covered by the electrodes 32. Consequently, the outer surfaces of the electrodes 32 covered by the parylene film 38 also become rough surfaces, and the probability of generation of pinholes on the parylene film 38 increases. In order to prevent generation of pinholes on the parylene film 38, it is preferred that the film thickness of the parylene film 38 be 3 μm or thicker.

As shown in FIG. 5, a barrier film 39 is deposited on the parylene film 38. According to an embodiment, the barrier film 39 is formed from an organic material, such as silicon nitride film. The silicon nitride film has the barrier function of suppressing penetration of moisture and impurities, and, at the same time, possesses excellent electrical insulating properties.

According to the present embodiment, the barrier film 39 is formed on the parylene film 38 using, e.g., the PE-CVD method (plasma-enhanced chemical vapor deposition). The silicon nitride film obtained using the PE-CVD method does not contain oxygen in its composition. In addition, the silicon nitride film is deposited on the parylene film 38 in a vacuum atmosphere. Thus, it is possible to exclude oxygen from between the silicon nitride film and the parylene film 38. Consequently, the silicon nitride film deposited on the parylene film 38 in the vacuum atmosphere is a preferable barrier film 39 possessing oxygen barrier characteristics.

The barrier film 39 covers the entire surface of the parylene film 38 inside the pressure chambers 31 of the inkjet head 1. Consequently, the barrier film 39 is exposed inside the pressure chambers 31, and it isolates the parylene film 38 from oxygen. According to an embodiment, the film thickness of the barrier film 39 is preferably 1 μm or thicker.

The inkjet head 1 of the present embodiment has the parylene film 38 for protecting the electrodes 32 covered by the barrier film 39. As an example, the barrier film 39 is made of silicon nitride film, wherein no oxygen is contained in the composition, and it is deposited on the parylene film 38 in vacuum. As a result, there is no oxygen between the barrier film 39 and the parylene film 38.

Consequently, the parylene film 38 is isolated from oxygen, and degradation of the parylene film 38 by oxygen can be prevented. Therefore, it is possible to maintain good electrical insulation between the ink fed to the pressure chambers 31 and the electrodes 32 over a long period of time. Even when the ink is electroconductive, it is still possible to avoid corrosion of the electrodes 32 and electrolysis of the ink caused by the flowing of current in the ink. Consequently, it is possible to obtain an inkjet head 1 with excellent printing quality and durability.

In addition, according to the present embodiment, the outer surface of the parylene film 38 covering the electrodes 32 becomes a rough surface as influenced by the bumps/dips 28 on the bottom surfaces 24 and the side surfaces 25a, 25b of the slots 22. As a result, the barrier film 39 assumes the shape of the fine bumps/dips 28 present on the outer surface of the parylene film 38. Consequently, the close contact property of the barrier film 39 on the parylene film 38 is increased. Therefore, it is possible to form the barrier film 39, such as a silicon nitride film, having the desired oxygen barrier property reliably on the parylene film 38.

In the following, the electrical insulating property of the parylene film 38 will be explained with reference to the mode wherein the electrical insulating property degrades by oxygen.

As shown in chemical formula 1, the parylene film 38 has a structure wherein plural benzene rings are bonded via plural methylene groups (CH₂).

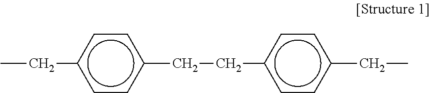

When the parylene film 38 receives UV light, heat or other external energy in an oxygen atmosphere, as shown in chemical formula 2, the portion of the methylene group (CH₂) is oxidized to a ketone group (CO). That is, as the bonds between the atoms in oxygen are broken, the electrical insulating property of the parylene film 38 degrades.

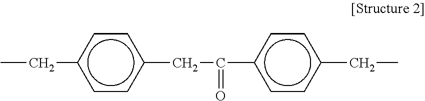

FIG. 6 is a diagram illustrating the UV absorption spectrum of the parylene film 38 deposited on the electrodes. In FIG. 6, peak A indicates the main peak of ketone observed after irradiation by UV light on the parylene film 38 in an oxygen atmosphere. In the step before irradiation by UV light on the parylene film 38 in an oxygen atmosphere, absorption of the ketone groups is not observed. However, after irradiation by UV light on the parylene film 38, absorption by ketone groups is observed as shown in FIG. 6. According to the present embodiment, the absorptivity of the ketone groups observed here is 1700 cm⁻¹.

Consequently, it can be seen that when external energy, such as UV light, is irradiated on the parylene film 38 in an oxygen atmosphere, the electrical insulating property of the parylene film 38 degrades. For the parylene film, the crystal structures of other types are different. However, the parylene film possessing methylene groups (CH₂) in its structure has degraded electrical insulating property due to this principle.

The parylene film 38 is covered by the barrier film 39, which is made of, for example silicon nitride film containing no oxygen. Moreover, oxygen is excluded from between the parylene film 38 and the barrier film 39, so that it is possible to prevent degradation of the parylene film 38 caused by oxygen.

The barrier film is not limited to the silicon nitride film. One may also adopt, e.g., titanium nitride film in place of the silicon nitride film.

Additionally, the method for depositing the barrier film on the parylene film 38 is not limited to the PE-CVD method. Any method may be adopted as long as it is possible to deposit an organic feed material containing no oxygen on the parylene film in a vacuum.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet head comprising:
a pressure chamber configured to pressurize ink;
a nozzle connected to the pressure chamber configured to eject the ink;
an electrode arranged in the pressure chamber, the electrode configured to receive a driving voltage to deform the pressure chamber in order to apply pressure on the ink;
a parylene film covering the electrode configured to protect the electrode from the ink, and a barrier film deposited on the parylene film configured to isolate the parylene film from oxygen.

2. The inkjet head according to claim 1, wherein
a surface of the electrode covered by the parylene film is a rough surface.

3. The inkjet head according to claim 2, wherein
a surface of the parylene film covered by the barrier film is a rough surface.

4. The inkjet head according to claim 1, wherein
the barrier film is configured to exclude oxygen from between the parylene film and the barrier film.

5. The inkjet head according to claim 1, wherein the pressure chamber comprises two piezoelectric members having polarization direction opposite to each other.

6. The inkjet head according to claim 1, wherein the barrier film is a silicon nitride film formed in a vacuum.

7. The inkjet head according to claim 1, wherein a ratio of a height of the pressure chamber to a width of the pressure chamber is greater than 1.0.

8. An inkjet head comprising:
a pressure chamber configured to pressurize ink;
an electrode arranged in the pressure chamber, the electrode configured to receive a driving voltage applied to it to deform the pressure chamber in order to apply pressure on the ink;
a parylene film covering the electrode in the pressure chamber, and
a barrier film deposited on the parylene film which contains no oxygen and is exposed in the pressure chamber.

9. The inkjet head according to claim 8, wherein
a surface of the electrode covered by the parylene film is a rough surface.

10. The inkjet head according to claim 9, wherein
a surface of the parylene film covered by the barrier film is a rough surface.

11. The inkjet head according to claim 8, wherein the barrier film is configured to exclude oxygen from between the parylene film and the barrier film.

12. The inkjet head according to claim 8, wherein the pressure chamber comprises two piezoelectric members having polarization directions opposite to each other.

13. The inkjet head according to claim 8, wherein the barrier film is a silicon nitride film formed in a vacuum.

14. The inkjet head according to claim 8, wherein a ratio of a height of the pressure chamber to a width of the pressure chamber is greater than 1.0.

15. A method of forming an inkjet head, the method comprising:
forming a slot in a body;
bonding a nozzle plate having a nozzle to the body to cover the slot and to form a pressure chamber;
forming an electrode in the slot, the electrode configured to receive a driving voltage to deform the pressure chamber in order to eject ink from the nozzle;
forming a parylene film on the electrode, the parylene film configured to protect the electrode from the ink;
forming a barrier film on the parylene film, the barrier film configured to isolate the parylene film from oxygen.

16. The method according to claim 15, wherein the step of forming the barrier film comprises forming the barrier film using plasma-enhanced chemical vapor deposition.

17. The method according to claim 16, wherein barrier film is a silicon nitride film.

18. The method according to claim 17, wherein the silicon nitride film is formed in a vacuum.

19. The method according to claim 15, wherein the step of forming the slot comprises cutting the slot in the body using a diamond blade.

20. The method according to claim 15, wherein:
the slot includes a first rough surface; and
the barrier film is formed on a second rough surface of the parylene film, the second rough surface corresponding to the first rough surface.
